(19) United States
(12) Patent Application Publication
(10) Pub. No.: US 2008/0200110 A1
(43) Pub. Date: Aug. 21, 2008

(54) Box vane mixing element for automotive heating, ventilating and air conditioning system

(76) Inventors: Debashis Ghosh, Williamsville, NY (US); Garrett Wade Hoehn, Kenmore, NY (US)

Correspondence Address: DELPHI TECHNOLOGIES, INC., M/C 480-410-202, PO BOX 5052, TROY, MI, 48007, US

(21) Appl. No.: 11/475,563

(22) Filed: Jun. 27, 2006

Related U.S. Application Data
(60) Provisional application No. 60/694,387, filed on Jun. 27, 2005.

(51) Int. Cl. B60H 1/34

(52) U.S. Cl. 454/160

(57) ABSTRACT

An HVAC housing assembly includes a novel structure to aid the mixing of hot and cold air downstream of the evaporator and heater core. One or more variable nozzles are carried for displacement with the temperature door for accelerating some of the cold air stream through an internal housing opening and varying the cold air stream impingement angle with the hot air stream at their point of confluence to establish secondary mixing sites and substantially improving the resulting heat transfer coefficient.

### RELATED PATENT APPLICATION

This application claims priority to U.S. Provisional patent application Ser. No. 60/694,387 filed 27 Jun. 2005, entitled “Box Vane Mixing Element for Compact Mixing of High Velocity and Low Velocity Streams at Widely Different Incoming Temperatures”.

### TECHNICAL FIELD

The present invention relates to heating, ventilating and air conditioning systems in general, and specifically to such systems which are adapted for automotive applications in which the housing or module incorporates an improved means for mixing heated and cooled air.

### BACKGROUND OF THE INVENTION

Automotive heating, ventilating and air conditioning (hereinafter “HVAC”) systems, typically contain features and components exemplified in drawing FIG. 1. Referring first to FIG. 1, a typical HVAC housing, indicated generally at 10, is a large hollow box, generally a multi-piece unit built up out of two or more molded plastic sub-sections. A non-illustrated blower and scroll housing draw in air and force it through the housing 10, first through an evaporator 12, through which the entire air flow initially passes, and then toward a heater core 14. While the evaporator 12 always has air flow through it, it may or may not be active and cold, depending on whether the associated compressor (non-illustrated) is active. However, the compressor is always cold relative to the heater core 14, which has a continuous flow of engine coolant flowing through it.

Air flow through the evaporator 12 and heater core 14 is controlled by a series of internal walls, ducts and doors. In general, the air stream is bifurcated or split between a heated stream and a cold stream, and then the two streams are reintroduced downstream to, at least ideally, remix to a mid temperature, which depends on the proportion of the split. Specifically, an upper interior wall 16 downstream of evaporator 12 has an internal opening 18, and cold air that passed through evaporator 12 passes straight through opening 18, unless it is blocked totally by a flapper type temperature door 20. A lower interior wall 22 has an air inlet opening 24, which, unless it is blocked by the temperature door 20, passes some of the air that has passed through the evaporator 12 through the heater core 14. The degree of the split in streams between the two heat exchangers is dependent on the relative position of the temperature door 20, which can swing back and forth to apportion the air flow through both openings 18 and 24.

The separate air flow (if any) diverted through opening 24 and through the heater core 14 is routed by another internal wall, which effectively creates an internal hot air duct 26 that ends adjacent opening 18. The internal hot air duct ends just below a central mix area labeled “M”. There, the bifurcated hot air flow is routed transversely across the outside of the internal opening 18, generally normal to the cold air flow passing through opening 18. Any separate identity of the hot air flow is quickly erased, however, as it engages the cold air flow that has exited opening 18 and the two flows mix, at least ideally, to achieve a final net temperature. From the final mix air, some flow is routed to one of several possible ducts, which are connected to outlet openings in the housing 10. Specifically, an uppermost duct 28 (generally called the window defroster duct), a mid level duct 30, and a lower heater duct 32, all receive an air flow as determined by some dedicated opening and closing means, generally referred to as a mode control. In the embodiment disclosed, the mode control is a film belt or belts 34. Separate flapper type doors could also be used.

A continuing problem has been the actual attainment of a good mix of cold and hot air within the mixing space M. The two air streams have a tendency to stratify without mixing. Cold air coming out of evaporator 12 will shoot straight up and out of the defroster duct 28, for example, without the desired level of mixing with hot air that has passed through the heater core 14. Known means of promoting mixing have not proved entirely satisfactory, because of cost, complexity or an undesirable extra pressure drop in the air stream. One known means includes additional dedicated ducts within the housing 10, referred to as bleed ducts, which direct a portion of the hot air coming off the heater core 14 around and deliver it directly to or below the defroster duct 28. Another means is a separate and additional valve door that is slaved to the mode control door, and which extends out into the mix area to promote turbulence and mixing.

The use of baffles attached to the temperature door 20 has been proposed to increase mixing of the bifurcated hot and cold air streams. Such baffles are typically aligned with the main flow in a cross-stream direction. Because the baffles are positioned perpendicular to the main flow, they create vortices, which are shed downstream and impose several limitations.

Most significantly, the addition of baffles chokes the main flow and adds a large pressure drop. The increase in pressure drop is highest when the temperature door 20 is in the “full cold” setting, which is important for overall system operation. To be effective in promoting mixing a high velocity (ex.: 6 m/s) cold stream and a low velocity (ex.: 1.5 m/s) hot air stream, the size of the baffles have to be relatively large. Such large baffles shed large sized vortices or eddies, typically equal to the diametrical width of the baffle downstream of the baffle. Eddies downstream of the baffles induce significant amount of flow-induced noise noticeable in “vent” and “”bi-level” operating modes. The noise due to this cross flow baffle has been found to be most severe at the specification point with the temperature door 20 at a 50% position setting in the bi-level” operating mode. Additionally, by virtue of being attached to the temperature door 20, the baffle forces the hot/cold mixing to occur away from the ideal mixing zone (i.e., the source of hot air). The baffle pushes the main cold flow away from the hot air towards the mode doors where the cold flow can take a quick exit without mixing with hot air. This results in colder defrost and vent outboard temperatures which is responsible for windshield clearing.

Enhanced mixing has also been proposed by converging heater return flow. In this approach, the heater return wall is angled inwardly to accelerate the flow. This constricts the flow passage and increases pressure drop, which is particularly problematic in “heater” and “defrost” operating modes. The constriction created by the heater return wall creates a large pressure drop of the heater flow in making a u-turn, which slows vehicle warm-up. The increase in pressure drop due to high velocity (ex.: 26 m/s) in heater return flow reduces the total amount of air flow in “heater-full hot” and “defrost-full hot” operating modes. Having high airflow at these two design points is very important as it impacts vehicle warm up and windshield clearing time.

Open and closed tubes have been proposed for convecting hot air to the defrost outlets. However, such tubes carry a very low volume of air at the desired location. For example, one design analyzed by the applicants required about 9 cfm of hot air to adequately heat the defrost air. Six 15 mm diameter open “D” shaped tubes can carry about 2.75 cfm to the defrost, which is far less than the amount of hot air required to adequately heat the defrost air. Secondly, six 15 mm open or closed tubes represent an obstruction of about 30% on the airflow in the “vent” mode. This adds significant “AC” mode pressure drop.

### SUMMARY OF THE INVENTION

One of the main design challenges in current HVAC systems is achieving good mixing of hot and cold air in a very compact space. It is also required that this mixing be achieved efficiently in all the operational modes with a minimal impact on additional pressure drop and without adversely affecting the overall noise profile. The primary design issue at stake is getting an adequate amount of hot air to the defrost outlets and side vent outlets. Providing an adequate volume of hot air to the defrost outlets and side vent outlets is very important inasmuch as air exiting these outlets is responsible for achieving windshield clearing preventing fogging of the windshield.

The present invention provides a substantial volume of hot air to be directed to the defrost ducts and side vent ducts. It does so by enhancing mixing of hot and cold air streams with minimal impact on overall system pressure drop and without adversely affecting the noise profile, probably improving it. The inventive designs comprise an array of nozzles attached to the temperature valve creating the box vane. The nozzles are strategically positioned and aligned with the main flow making them move with the temperature door. By varying the flow direction or angling flow through the nozzles, the site of primary mixing is altered by bringing it close to the source of hot air and away from the different mode door exits. This is in contrast to current art where most of the mixing occurs at an undesirable location-away from the source of hot air and closer to the exit doors, whereby the cold air flow has an opportunity for a quick exit path without adequate mixing.

The nozzles fashion converging channels to the main flow thereby, allowing the cold flow to accelerate to a high rate of speed. Increase inflow speed through the nozzle results in significant increase in efficiency of mixing with hot air at an altered site. In addition, to altering the primary site of mixing, a new set of secondary mixing sites are created by feeding hot air upstream of the temperature valve. Promotion of secondary mixing sites allows one to achieve mixing close to the ideal mixing site, i.e. at the source of cold air exiting the evaporator.

With the nozzles of the inventive box vane design being aligned substantially in parallel to the main flow, the additional system pressure drop penalty is small. Additionally, the aligned flows do not result in an additional noise penalty inasmuch as the box vane doesn't shed large diameter energetic vortices to the downstream flow.

The subject invention provides a simpler and more cost effective means of promoting hot-cold air mix, which does not entail any extra closed ducts or valve doors, and which has a minimal impact on pressure drop and operating noise in the system.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a cross-sectional view taken through a prior art HVAC housing;

FIG. 2, is a cross-sectional view taken through a HVAC housing similar in some respects to that of FIG. 1, but illustrating the box vane mixing element of the present invention;

FIG. 2A, is a broken, cross-sectional view of the HVAC temperature door and box vane mixing element of FIG. 2, on an enlarged scale and with the temperature door in alternative limits of travel;

FIG. 3, is a perspective view of the preferred embodiment of the temperature door and box vane mixing element of FIG. 2;

FIG. 4, is a graphical depiction of a baseline HVAC design (without a box vane mixing element) in defog mode, illustrating an air temperature versus temperature door position operating characteristic;

FIG. 5, is a graphical depiction of the HVAC design of FIG. 4, but with the box vane mixing element of FIG. 3 added, illustrating an air temperature versus temperature door position operating characteristic;

FIG. 6, is a perspective view of a first alternative embodiment of the temperature door and box vane mixing element of FIG. 2;

FIG. 7, is a perspective view of a second alternative embodiment of the temperature door and box vane mixing element of FIG. 2;

FIG. 8, is an alternative perspective view of the second alternative embodiment of the invention of FIG. 7, with the addition of an adjacent portion of the cooperating HVAC upper interior wall;

FIG. 9, is a perspective view of a third alternative embodiment of the temperature door and box vane mixing element of FIG. 2;

FIG. 10, is a perspective view of a forth alternative embodiment of the temperature door and box vane mixing element of FIG. 2;

FIG. 11, is a graphical depiction of the effect of a box vane on percentage flow rate through the heater core in the defrost mode of the embodiment of the invention of FIG. 9; and

FIG. 12, is a graphical depiction of the temperature difference between heater minus defrost and heater minus side vent in the defog mode with and without the box vane of the embodiment of the invention of FIG. 9.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED AND ALTERNATIVE EMBODIMENTS

The present invention is intended for application in automotive vehicle applications and will be described in that context. It is to be understood, however, that the present invention could also be successfully applied in many other applications. Accordingly, the claims herein should not be deemed limited to the specifics of the preferred and alternative embodiments of the invention described hereunder.

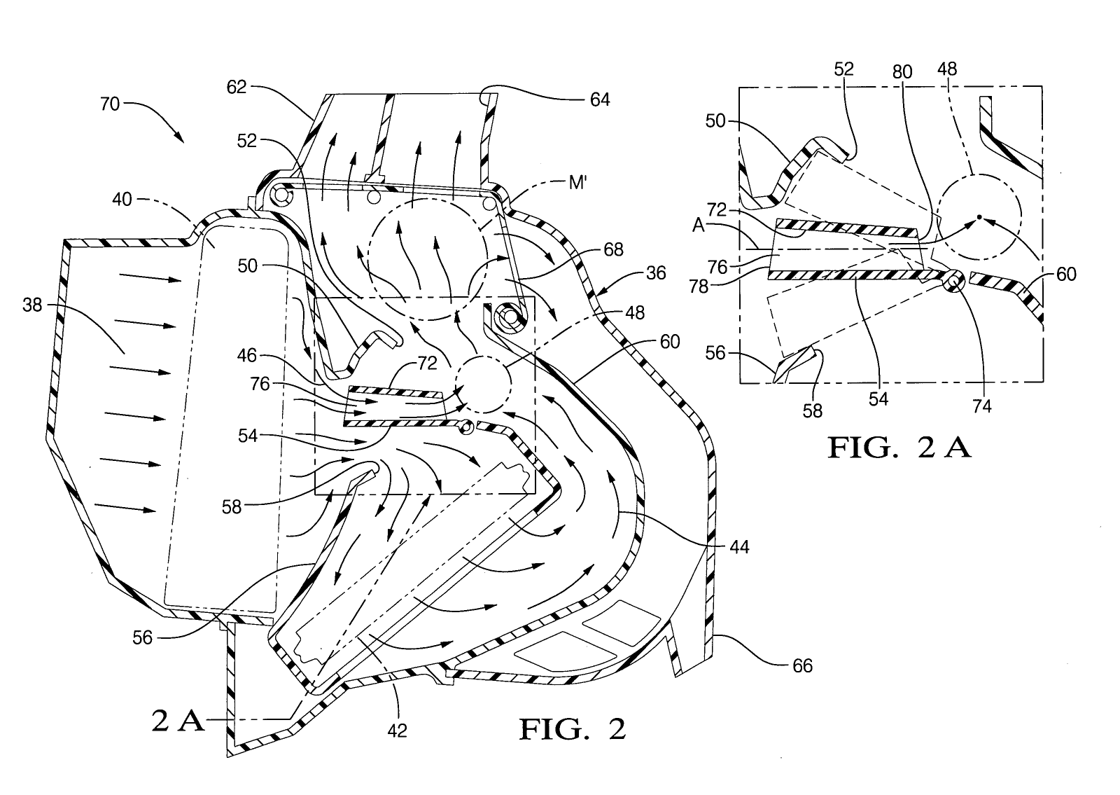

Referring to FIGS. 2 and 2A, a HVAC housing, indicated generally at 36, is a large hollow box, generally a multi-piece unit built up out of two or more molded plastic sub-sections. A non-illustrated blower and scroll housing draw ambient or inlet air 38 and force it through the housing 36, first through an evaporator 40, through which the entire air flow 38 initially passes, and then toward a heater core 42. While the evaporator 40 always has air flow through it, it may or may not be active and cold, depending on whether the associated compressor (non-illustrated) is active. However, the compressor is always cold relative to the heater core 42, which has a continuous flow of engine coolant flowing through it.

Air flow through the evaporator 40 and heater core 42 is controlled by a series of internal walls, ducts and doors. In general, the air stream 38 is bifurcated or split between a heated stream, designated generally at 44, and a cold stream, designated generally at 46. The two streams 44 and 46 are subsequently reintroduced downstream to, at least ideally, remix to a mid temperature at a region of confluence, indicated generally at 48, the mid temperature depending on the proportion of the split. Specifically, an upper interior wall 50 downstream of the evaporator 40 has an internal opening 52, and cold air that has passed through the evaporator 40 passes straight through opening 52, unless blocked totally by a flapper type temperature door 54. A lower interior wall 56 has an air inlet opening 58, which, unless it is blocked by the temperature door 54, passes some of the air that has passed through the evaporator 40 through the heater core 42. The degree of the split in streams 44 and 46 between the two heat exchangers is dependent upon the relative position of the temperature door 54, which can swing back and forth to apportion the air flow through both openings 52 and 58.

The separate air flow (if any) diverted through opening 58 and through the heater core 42 is routed by another internal wall, which effectively creates an internal hot air duct 60 that ends adjacent opening 52. The internal hot air duct 60 ends just below a central mix area labeled M′ which is downstream of the region of confluence 48 for final co-mingling and mixing of the air streams 44 and 46. There, the bifurcated hot air flow 44 is routed transversely across the outside of the internal opening 52, generally normal to the cold air flow 46 passing through opening 52. Any separate identity of the hot air flow 44 is quickly erased, however, as it engages the cold air flow 46 that has exited opening 52 and the two flows 44 and 46 mix, at least ideally, to achieve a final net temperature. From the final mix air, some flow is routed to one of several possible ducts, which are connected to inlet openings in the housing 36. Specifically, an uppermost duct 62 (generally called the window defroster duct), a mid-level duct 64, and a lower heater duct 66, all receive an air flow as determined by some dedicated opening and closing means, generally referred to as a mode control. In the embodiment disclosed, the mode control is a film belt or belts 68. Separate flapper type doors could also be used.

As is best seen in FIG. 2A, a housing assembly 70 embodying the present invention includes the housing 36, temperature door 56 and one or more nozzles 72 which is carried for displacement with the temperature door 54. The temperature door 54 and nozzle(s) 72 are carried as a single integrated unit for rotation about a pivot bearing 74 between a first limit of travel (illustrated in phantom in the uppermost position) and a second limit of travel (illustrated in phantom in the lowermost position). The temperature door 54 and nozzle 72 is also depicted in an intermediate position (in solid line) to illustrate their typical sectional structure.

Nozzle 72 is preferably integrally formed with temperature door 54 from injection molded thermoplastic material. The nozzle 72 forms a through passage 74 having an axis of elongation designated A-A, an inlet opening 78 and an outlet opening 80.

In its first limit of travel, the temperature door 54 and nozzle 72 abut a stop feature formed in the upper interior wall 50 to effectively close internal opening 52, whereby virtually the entire inlet air flow 38 is diverted into heated air stream 44 through air inlet opening 58. In the first limit of travel, a portion of the upper interior wall 50 is in close proximity to the inlet opening 78 of through passage 76, preventing any air flow therethrough. This corresponds to the maximum hot setting of the host HVAC system.

In its second limit of travel, the temperature door 54 and nozzle 72 abut a stop feature formed in the lower interior wall 56 to effectively close internal opening 58, whereby virtually the entire inlet air flow 38 is diverted into cold air stream 46 through air inlet opening 52. In the second limit of travel, a portion of the cold air stream 46 passes through nozzle 72 and the remainder passes through air inlet opening 52 externally of nozzle 72.

In operation, as the temperature door 54 and nozzle 72 is repositioned from the first limit of travel, towards the second limit of travel, the portion of the cold air stream 46 passing through the nozzle 72 will vary as a function of the door's angular position. This feature renders the nozzle 72 variable.

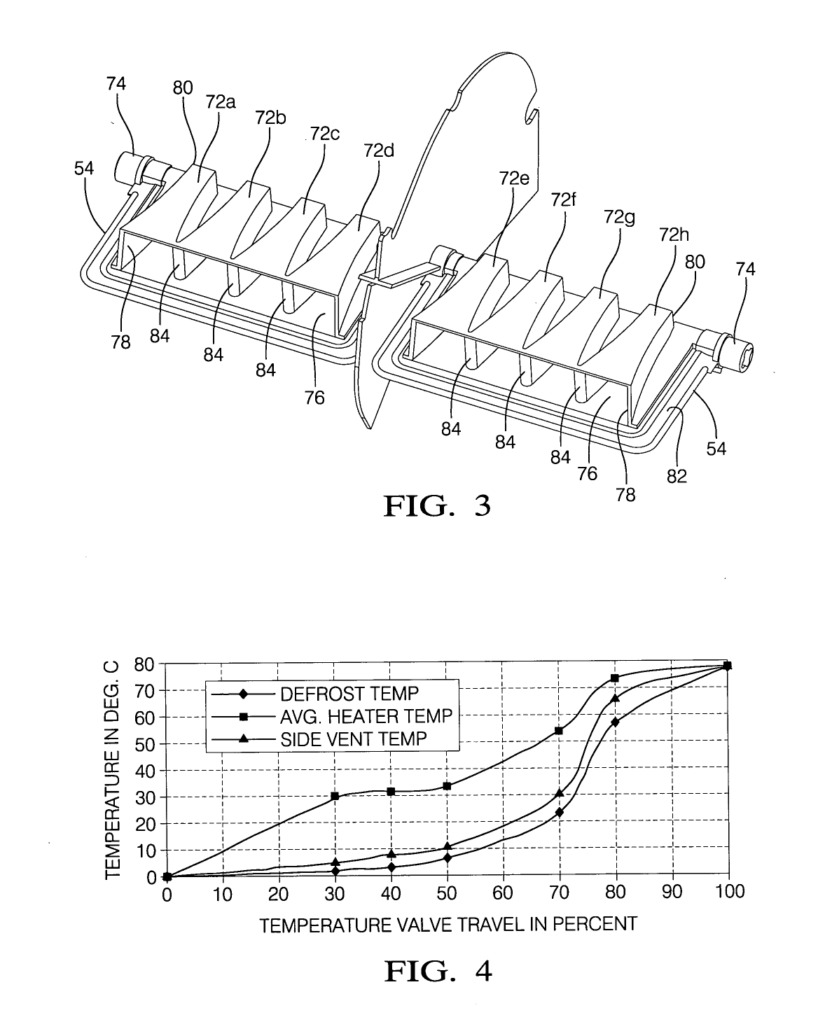

Referring to FIG. 3, each zone of the host HVAC system includes a temperature door 54 which is substantially flat/planer and rectangular in shape. An array of nozzles 72a -72h are carried on the downstream surface sides of the temperature doors 54 and arranged to cover substantially the entire surface areas of the doors 54. A peripheral seal 82 alternatively engages the upper and lower interior walls 50 and 56, respectively, to prevent air blow-by when the temperature door 54 is in one of its limits of travel. Each of the nozzles are similarly shaped and dimensioned and are tapered as the through passages 76 transition from the inlet openings 78 toward the outlet openings 80. Adjacent nozzles 72 have integral webs 84 extending there between to prevent cold air 46 from bypassing the respective through passages.

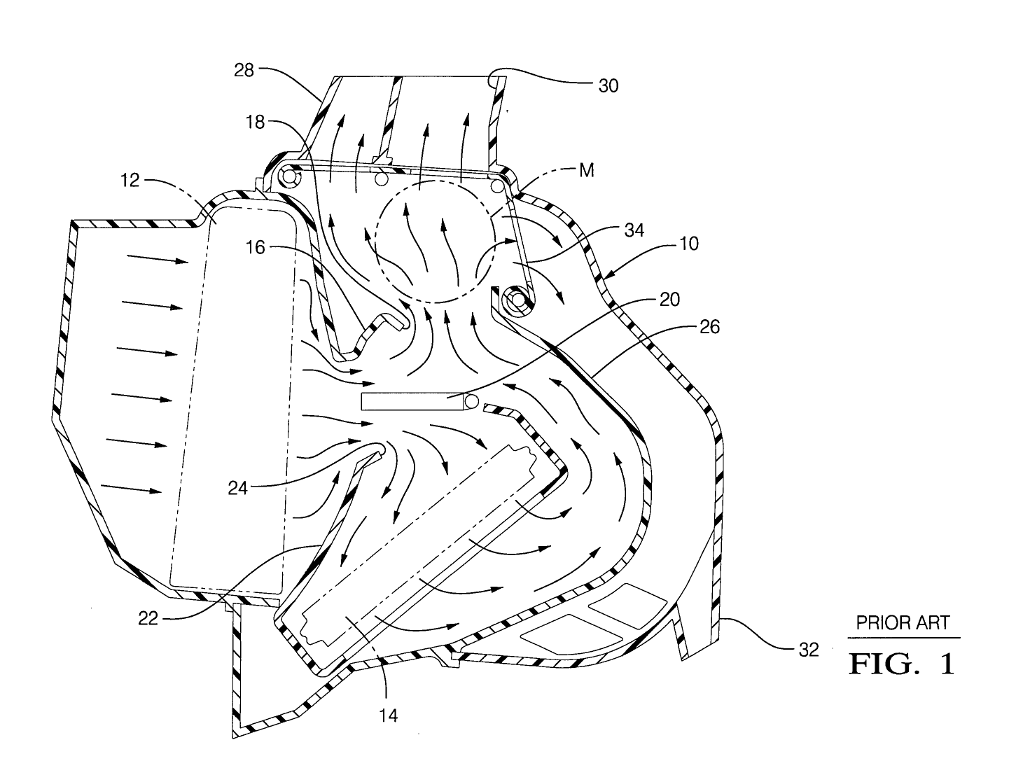

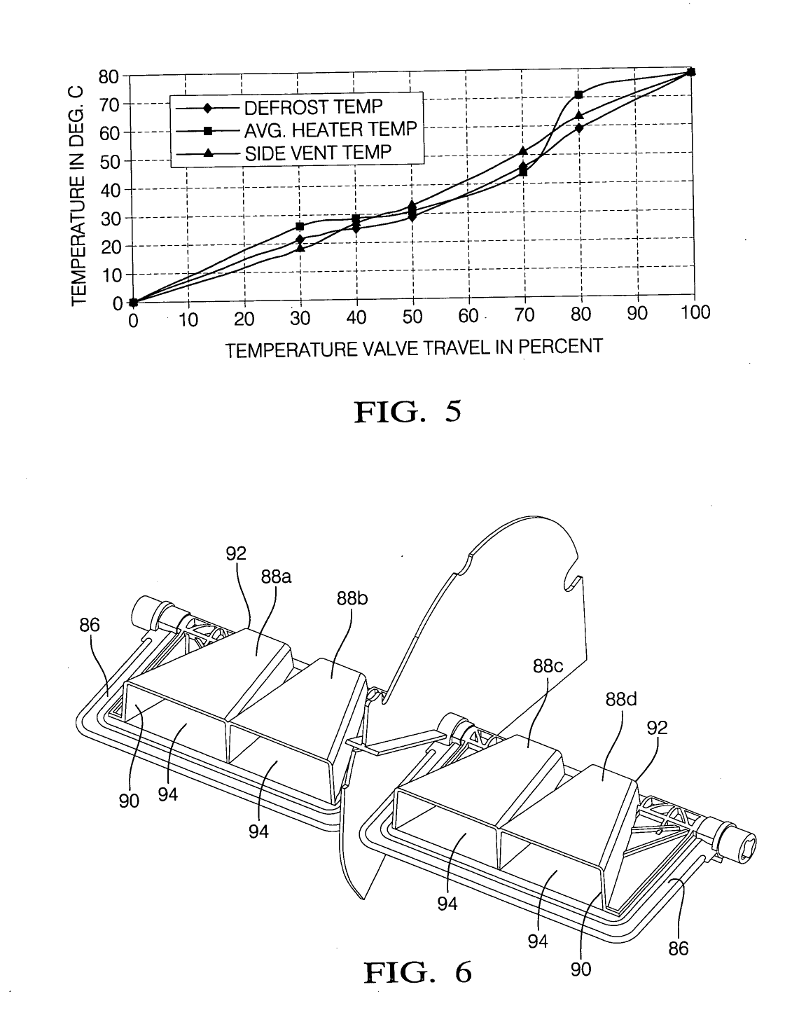

FIG. 4 graphically illustrates the HVAC system defrost, heater and side vent temperature as a function of the temperature door setting as illustrated in FIGS. 1-3, but with the nozzles 72a -72h removed. By contrast, FIG. 5 graphically illustrates the same performance metrics of the HVAC system of FIGS. 1-3, including the nozzles 72a -72h.

Note the substantially improved linearity of the overall performance throughout the full range of temperature door settings, as well as greater consistence of temperature at the several system outlets (defrost, heater, side vent).

The preferred embodiment of FIGS. 2, 2A, 3 and 5 represents the most generalized mixing scheme of the proposed invention. In this embodiment, the array of nozzles 72a -72h are integrated into the temperature door 54. Each through passage 76 through the nozzle 72 associated with it is an extension in the heater return wall 50. The nozzles 72 on the temperature door 54 may be all of the same size different sizes depending on local mixing requirements. Similarly, the extensions on the heater return wall may be all of the same length or different lengths depending upon the degree of hot feed required to the frost and vent outlets.

The nozzles 72 collect cold incoming air 46 from the evaporator 40 and feeds it to the primary mixing site corresponding with the region of confluence 48 to mix with the hot fluid 44 coming from the hearer core 42. The multiple curved extensions of the heater return wall helps to feed hot air upstream towards the source of the cold air 46 coming from the evaporator 40. This raises the temperature of the air leaving the defrost and side vent outlets. The upstream feed of hot air 44 is further augmented via the outer diverging channels of the nozzles that feed hot air convergingly upstream.

Theoretically, the number oz nozzles 72 that could be employed on the temperature door 54can range from 1 to infinity and associated with it the number of extensions can range from 1 to infinity for perfect mixing. For reasons of manufacturability, the number of nozzles 72 in the array is shown as 8 and associated with it are the curved heater wall extensions. The length of the extensions in the curved wall are decided based on end temperature conditions in defrost and side vent outlets.

The nozzles 72 can have various shapes/configurations which vary from planar to circular or any hybrid combination thereof. The nozzle 72 contraction or restriction in the direction of flow (from the inlet opening 100 to the outlet opening 102) can be made to vary from any shape—linear, ponomial, hyperbolic, exponential, etc. Depending on the turbulence modulation to be achieved and the degree of acceleration of the nozzle stream required for heat transfer enhancement. Exponential nozzle profiles will accelerate the incoming air stream very rapidly in a very short nozzle length to a very high rate of speed at the primary mixing zone making the design quite compact. However, pressure drop penalty in such case will be higher.

FIG. 6 illustrates an alternative embodiment of the present invention including a two-zone temperature door 86 and nozzles 88 carried therewith. The only significant difference between this alternative embodiment and the preferred embodiment described in relation to FIG. 3, is that the embodiment of FIG. 6 contains two nozzles 88 on each temperature door 86 and each nozzle 88 is linearly tapered as it transitions from its relatively large inlet openings 90 to its relatively small outlet openings 92 of its through passages 94 along its characteristic lines of elongation.

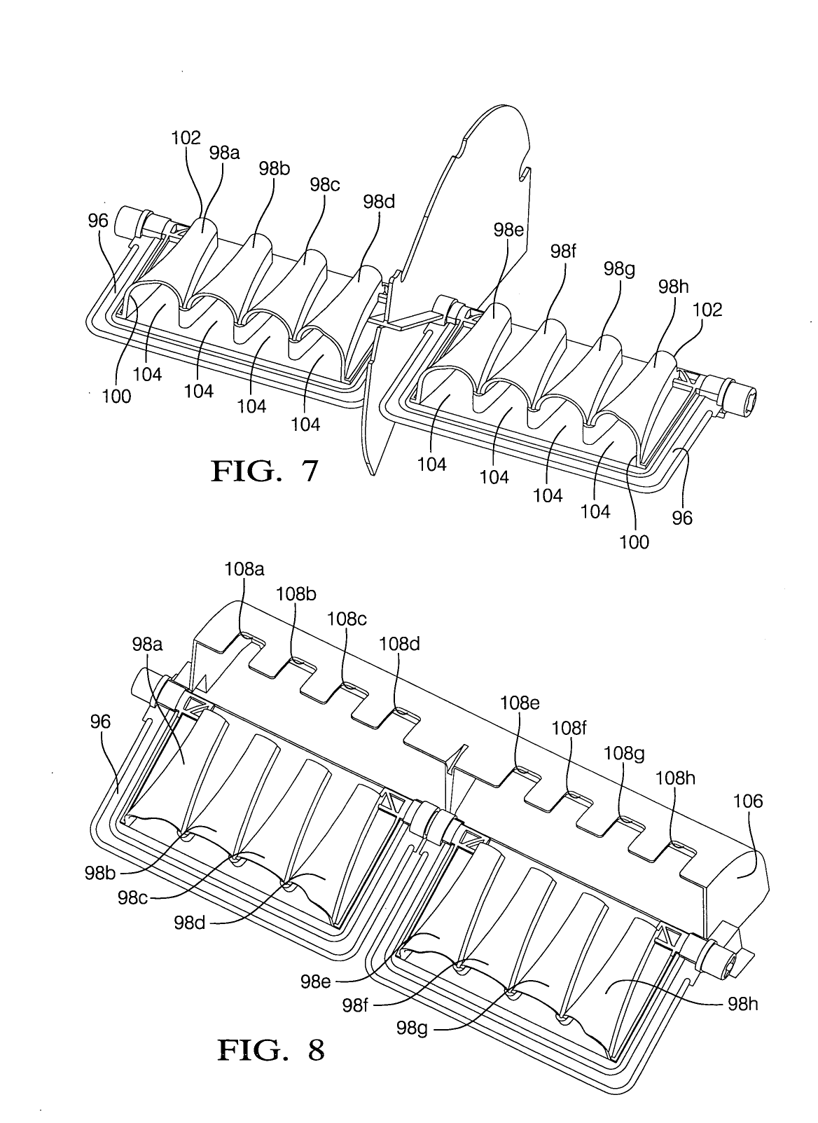

FIGS. 7 and 8 illustrate a second alternative embodiment of the present invention including a two-zone temperature door 96 and nozzles 98 carried therewith. The only significant difference between the second alternative embodiment and the preferred embodiment described in relation to FIG. 3, is that the embodiment of FIGS. 7 and 8 the nozzles are semi-circular and hyperbolic in shape and have lines of elongation between relatively large inlet openings 100 and relatively small outlet openings 102 which vary in length. Each or the nozzles 98a -98h are non-linearly tapered. Furthermore, a portion of the fixed interior wall 106 of the associated HVAC housing defines shaped recesses 108a -108h adapted to conform to the outer surface of their respective nozzles 98a -98h. This feature enhances compactness of the overall HVAC package as well as improves temperature door 96 to interior wall 106 sealing.

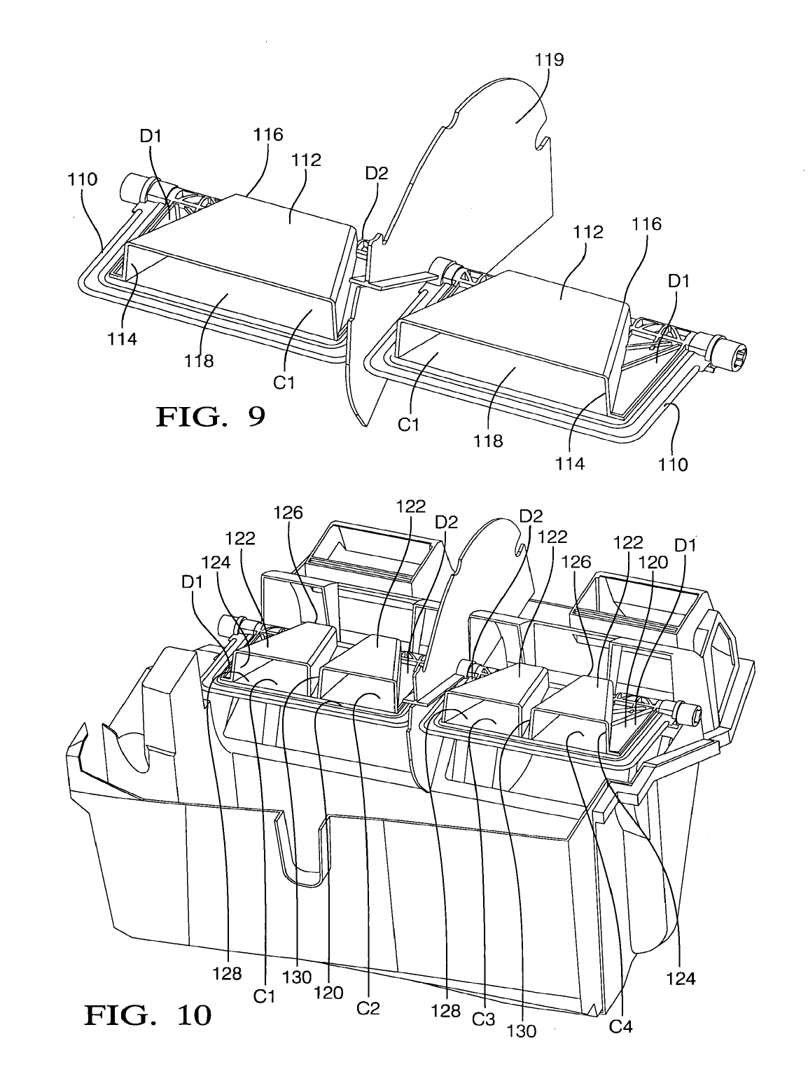

FIG. 9 illustrates a third embodiment of the present invention including a two-zone temperature door 110 and nozzles 112 carried therewith. The only significant difference between the third alternative embodiment and the preferred embodiment of the invention described is relation to FIG. 3, is that in FIG. 9, each temperature door 110 caries a single linear nozzle 112 which has a relatively large inlet opening 114 and a relatively small outlet opening 116 at respective ends of a through passage 118. The embodiment of FIG. 9 depicts one of the most simple cases of the mixing scheme enunciated above when the number of nozzles 112 “N” equals 2. The curved wall in that case has three extensions at the ends and in the middle for feeding hot air upfront making it shaped like an “E”. The temperature door 110 resembles a flat wall with one nozzle 112 for each half of the HVAC case 36 bisected in the middle by a separator wall 119.

The benefits of the proposed invention are most easily described with this embodiment. For that reason, the box vane temperature door 110 in the HVAC module was most widely studied in the different HVAC modes. Well known techniques of Computational Fluid Dynamic Analysis commonly called CFD analysis were applied for doing the fluid-thermal simulation. Merits of the box vane design in the proposed design is aptly apparent when reviewing the fluid-thermal data with and without the box vane as described below.

The array of nozzles constituting a box vane temperature door performs four main functions. First, it acts as a dynamic valve. Second, it enhances mixing by altering the site of primary mixing away from the mode doors. Third, it enhances mixing by increasing the intensity of heat transfer at the primary site by accelerating both the hot and cold impinging streams to higher velocity. Fourth, it promotes secondary mixing by feeding hot air to the source of cold air upstream of the HVAC module.

In addition to the above fluid-thermal functions the box vane can also be made to act as a flow straightener thereby potentially reducing noise due to vortex shedding. Another important outcome of the proposed invention is the ability to shape the temperature fall coming off from full hot to a stretched “S” shape for linear temperature door travel. This prevents very rapid drop in heater and defrost outlet temperatures when the temperature door is open up to approximately 80% from full hot.

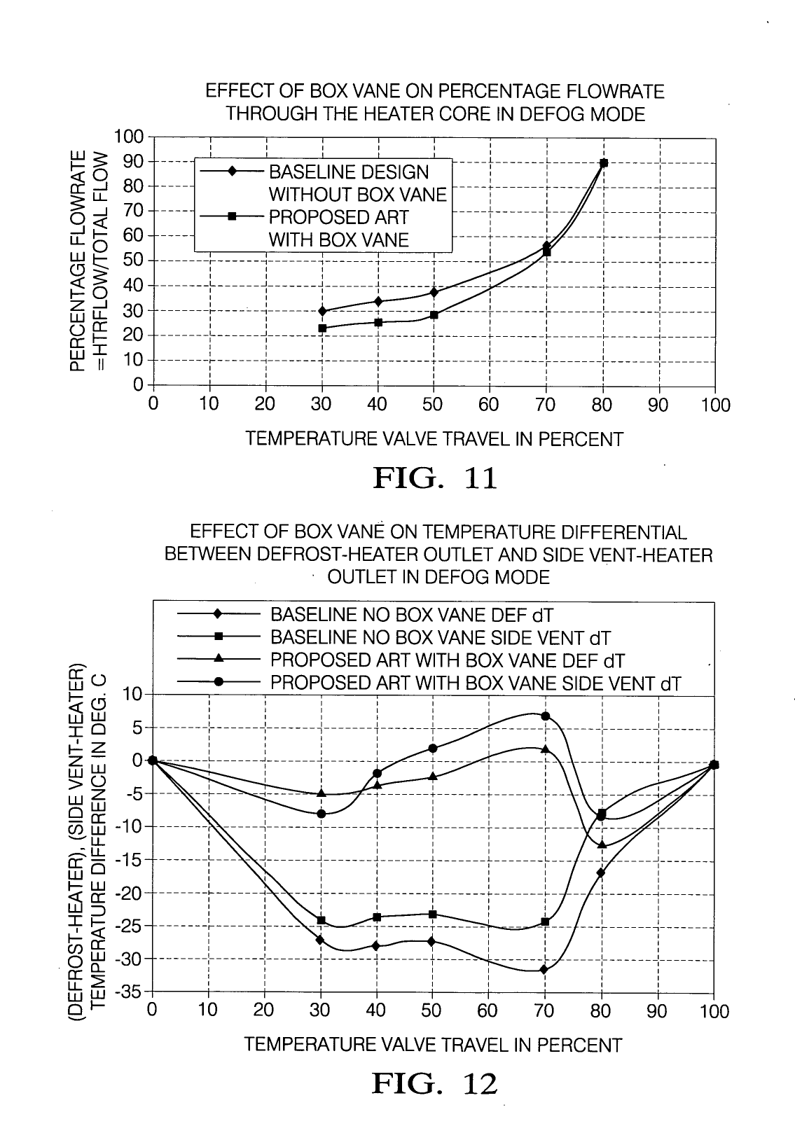

The nozzles of the box vane, by virtue of being attached to the temperature door as shown in FIG. 9, function like a moving valve. In concert with the temperature door it dynamically regulates the flow split going through the heater core and the cold bypass flow. FIG. 11 shows the increase in flow through the heater core with and without the box vane. This fact is illustrated by analyzing the flow in defog mode when it is most difficult to get hot air to the defrost outlets. The favorable impact of the dynamic valve function of the box vane is, however, not limited to defrost mode only. Other HVAC modes are also favorably impacted, e.g. heater, defrost and AC mode. For the sake of illustration, only defog mode linearity data obtained from CFD analysis is presented here as this mode poses the most challenge in obtaining hot defrost and side vent outlet temperatures.

For the design according to the embodiment of FIG. 9 at 50% temperature door position in defog mode, the flow through the heater core increases from 29% to 38%. In its entire usable range of operation in defog mode ranging from temperature door sweeping from 25% to 75%, the increase in heater flow attributed purely to box vane ranges from 7% at 30% temperature door position to 3% at 70% temperature door position.

Increased flow through the heater core implies higher heat transfer coefficient of mixing for the heated stream and higher heat rate “Q” or the total wattage measured in watts delivered by the heated stream to warm up the cold air.

The design of nozzles representing the converging channels of the box vane first allows collection of and then acceleration of the bypass flow to the primary mixing site. The additional pressure drop incurred by the cold bypass flow is attributed to the acceleration through the array of nozzles of the box vane and the blockage and friction posed by the walls of the box vane. Since air follows parallel paths of equal pressure drop, by increasing the pressure drop of the bypass stream it is possible to increase the flow rate of the heated stream going through the heater core.

It is important to realize that unlike the temperature door baffle of prior art as shown in FIG. 1, where the baffle is located in cross-stream to the main flow, the nozzles of the box vane are aligned with the main flow. Accordingly, the pressure drop and noise penalty is low. The most adverse additional system pressure drop penalty due to flow through box vane nozzles is less than 4% in AC full cold mode.

The nozzles of the box vane located on the temperature also changes the primary site of mixing from M to a new upstream site. In prior art shown in FIG. 1, most of the mixing occurs away from the source of hot air and closer to the mode doors. This strategy of mixing is inefficient, as the bulk of the mixing occurs closer to the mode doors, thus nearer to the outlets, allowing cold air to quickly take an exit path of least resistance without meeting the hot air.

This quick flight of the stronger stream of cold air significantly lowers the residence time of the high velocity stream inside the module allowing less time for heat transfer between the hot and the cold stream. FIG. 4 shows the temperature predicted by computer simulation for unmodified temperature door. It is clearly evident from FIG. 4 that at 30% temperature door position the incoming air stream leaving the evaporator at 0 degrees C. exits the defrost duct almost unheated at 2 deg C., while the hot air leaves the heater duct at 29 deg C. For the entire range of usable operation the defrost air is significantly colder than the heater duct temperatures (greater than 27 deg C.). This is unacceptable posing clear evidence of unmixed stratified streams leaving the module.

However, the same design when enhanced with strategically placed nozzles comprising the box vane according to the design of FIG. 9, the mixing between the two streams is significantly improved. FIG. 12 shows the effect of the box vane in warming the defrost and side vent temperatures. This air stream is responsible for clearing the host vehicle windshield when it gets foggy. For almost the entire range of operation the defrost, side vent and heater duct outlet temperatures almost exit at the same temperature (less than 4 deg C. difference), clear evidence of excellent mixing.

Vastly improved dynamics of mixing effected by the present invention is achieved due to four main factors.

Firstly, altering the primary site of mixing from M to a location upstream increases the residence time of the cold bypass air stream before exiting the module. This increases the time available for heat transfer.

Secondly, the altered site of primary mixing enables mixing to occur much closer to the source of hot air. Thus mixing between the two streams occurs at much higher thermal potential, 75 deg C. air with 0 deg C. air in present invention contrasted with the prior art.

Thirdly, and very importantly, accelerating the bypass stream through an array of converging nozzles increases the jet exit velocity through the box vane. The additional pressure drop incurred in accelerating the bypass stream to high velocity jet results in higher heat transfer coefficient of mixing. The higher the velocity of the exiting jet, the higher is the heat transfer coefficient of mixing of the stream. The degree of acceleration, and thus the pressure drop of flow going through the box vane is dependent on the upper converging angle and lower converging angle. The efficiency of mixing is augmented not only due to higher velocity of the cold stream, but also due to concomitant benefit of box vane nozzles that the increases the strength of the heated stream delivering higher wattage at higher velocity at the new mixing site.

The embodiments of the invention of FIGS. 9 and 10 illustrate the following. When viewed from the evaporator end of an HVAC case the box vane resembles an alternating assembly of converging-diverging channels. The converging channels C1 carry all the cold bypass stream accelerating to high velocity at the nozzle exit. The diverging channels D1 being partitioned by the nozzle walls don't carry any cold upstream fluid. However, when viewed from the vantage point of the curved heater return wall, the diverging channel D1 appears to be a converging channel to the heater stream. Fluids always flow from higher pressure to lower pressure, often described as favorable pressure gradient. Bernoulli's law teaches that when flow cross-sectional area is high, velocity of flow is low and pressure s high. Similarly, when flow cross-sectional area is small, velocity of flow is high and pressure is low. Thus, a converging nozzle poses a case of favorable pressure gradient and a diverging channel a case of adverse pressure gradient to the same flow.

When viewed from the vantage point of evaporator exit the converging channels C1 appear favorable to the cold bypass flow but unfavorable flowing through the outer diverging channels D1. But when viewed from the vantage point of the new primary mixing cite, the channels Cl appear unfavorable to the heated stream, but favorable flowing through the diverging channels D1. Thus, the channels D1 appearing diverging to the cold flow appear as converging channels to the heated flow.

The channels D1 being positioned in the path of favorable pressure gradient to the heated air stream allows one to conduct hot air upstream of the HVAC module. The open diverging channels D1 thus allows one to dump hot air as close to the source of cold air as possible. This is not possible in any known prior art. The dumping of hot air close to the evaporator creates additional mixing sites upstream. This results in heating the bypass stream sooner. Because the velocity of hot air reaching the secondary mixing site is much lower than the incoming cold stream, the intensity of mixing is lower. This is why the mixing occurring at the upstream site is termed as secondary mixing.

The embodiment of the invention depicted in FIG. 6 illustrates four nozzles, with no gap between the nozzles. The individual nozzles may be of same or different dimensions, different nozzle angles, and nozzle length.

The embodiment of the invention depicted in FIG. 10 has four nozzles, but the box vane permits flow between the nozzles. The converging channels C1, C2, C3 and C4 carry cold flow to the mixing site. The diverging channels D1 and D2 carries both cold and hot air. The spacing between the two nozzles C1 and C2 allows one to bleed some amount of cold air through an expanding channel D1. The flow path for this cold air is in direction of unfavorable adverse pressure gradient so cold flow rate is small. However, the same channel D1 being aligned in the path of favorable pressure gradient convects hot air upstream towards the evaporator to mix with the cold air. This air bleeding strategy in conjunction with the extensions of the central “E” wall allows one to modulate the defrost outlet temperatures when lower pressure drop is desired.

Additional flow and mix tempering features like slots and holes can be added to the active walls of the nozzles for locally modulating the final outlet temperatures. With a single 7 mm slot on the active wall of the nozzle, it is possible to reduce the side vent outlet temperatures from 26 deg C. to 19 deg C.

FIG. 10 illustrates a fourth embodiment of the invention including a two-zone temperature door 120, with each portion carrying two linearly tapered nozzles 122. Each nozzle 122 has a relatively large inlet opening 124 interconnected with an outlet opening 126 by a through passage 130. The nozzles 122 are spaced apart by a fixed bypass opening 130, which ensures that cold air flow is divided between a portion passing through the nozzles 122 and a portion passing exteriorly of the nozzles 122.

Each of the alternative embodiments of the invention described herein above can be applied with the HVAC housing 36 described in connection with FIGS. 2 and 2A.

It is to be understood that the invention has been described with reference to specific embodiments and variations to provide the features and advantages previously described and that the embodiments are susceptible of modification as will be apparent to those skilled in the art. The data presented is the result of theoretical and empirical testing as well as simulation based upon specific designs and applications, and is intended for example only.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, . . . It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. An automotive heating, ventilating and air conditioning housing assembly of the type wherein inlet air is bifurcated into a cold air stream and a hot air stream, with the cold air stream being routed through an internal housing opening and with the hot air stream being routed transversely across the downstream side of the internal housing opening, so that the hot and cold air streams combine at a region of confluence to be mixed to a mid temperature, said housing assembly comprising:
a housing;
a temperature door carried within said housing adjacent to said internal housing opening and displaceable between a first position to substantially obstruct said cold air stream and a second position to substantially obstruct said hot air stream; and
at least one nozzle carried for displacement with said temperature door, said nozzle defining a through passage for directing at least a portion of said cold air stream through said internal housing opening.

2. The housing assembly of claim 1, wherein said nozzle is a variable nozzle.

3. The housing assembly of claim 1, wherein airflow through said nozzle varies as a function of the position of said temperature door.

4. The housing assembly of claim 1, further comprising a plurality of nozzles carried for displacement with said temperature door, wherein each said nozzle defines a through passage for directing a portion of said cold air stream through said internal opening.

5. The housing assembly of claim 4, wherein each of said through passages define substantially parallel lines of elongation.

6. The housing assembly of claim 4, wherein each of said through passages is similarly shaped.

7. The housing assembly of claim 1, wherein said nozzle comprises an elongated passage extending between an inlet opening and an outlet opening.

8. The housing assembly of claim 7, wherein said nozzle is tapered along its characteristic line of elongation to effect acceleration of air flowing therein.

9. The housing assembly of claim 8, wherein said nozzle axially transitions from a relatively large inlet opening to a relatively small outlet opening.

10. The housing assembly of claim 9, wherein said nozzle transition is relatively linear.

11. The housing assembly of claim 9, wherein said nozzle transition is relatively non-linear.

12. The housing assembly of claim 1, wherein said nozzle is generally rectangular in cross-section.

13. The housing assembly of claim 1, wherein said nozzle is generally semi-circular in cross-section.

14. The housing assembly of claim 1, wherein said temperature door is relatively planar.

15. The housing assembly of claim 1, wherein said temperature door and nozzle are integrally formed.

16. The housing assembly of claim 1, further comprising recesses formed in said inner wall adapted to conform to outer surface portions of said at least one nozzle.

17. The housing assembly of claim 1, further comprising at least one cold air flow bypass passage.

18. The housing assembly of claim 17, wherein said bypass passage is disposed substantially parallel to said nozzle.

19. The housing assembly of claim 18, wherein said bypass passage is diverging.
